(19) United States
(12) Patent Application Publication
(10) Pub. No.: US 2012/0162196 A1
(43) Pub. Date: Jun. 28, 2012

(54) STEREO DISPLAY DEVICE

(75) Inventor: Shing Chia Chen, Taichung City (TW)

(73) Assignee: LARGAN PRECISION CO., LTD., Taichung City (TW)

(21) Appl. No.: 13/092,455

(22) Filed: Apr. 22, 2011

(30) Foreign Application Priority Data
Dec. 22, 2010 (TW) 099145147

(51) Int. Cl. G06T 15/00

(52) U.S. Cl. 345/419

(57) ABSTRACT

This invention provides a stereo display device for displaying left and right frames alternately with an adjusted disparity in between, comprising: a distance measurement module configured to measure the distance between the stereo display device and a viewer; and an adjustment module configured to receive left and right frames with an original disparity in between, adjust the original disparity between left and right frames according to the distance between the stereo display device and the viewer, and output left and right frames having an adjusted disparity in between.

### CROSS-REFERENCE TO RELATED APPLICATION

This non-provisional application claims priority under 35 U.S.C. §119(a) on Patent Application No. 099145147 filed in Taiwan, R.O.C. on Dec. 22, 2010, the entire contents of which are hereby incorporated by reference.

### BACKGROUND OF THE INVENTION

1. Field of the Invention

The present invention relates to a stereo display device, and more particularly, to a stereo display device capable of adjusting the disparity between left and right frames according to the distance between the stereo display device and a viewer.

2. Description of the Prior Art

A stereoscopic display device produces a stereoscopic effect by exploiting the binocular parallax of the left and right eyes. As the eyes are in slightly different biological positions of a human body, the views perceived are slightly different, and such binocular parallax contributes to the formation of a stereoscopic effect. A conventional stereo display device alternately displays left and right frames with a fixed disparity in between.

Generally, left and right frames are taken by different cameras and thus have a disparity in between. Therefore, the disparity between left and right frames is determined when left and right frames are taken and is associated with the distances between cameras and the object to be imaged. However, the distance between the stereo display device and the viewer may not be the same as the distances between cameras and the object to be imaged. Therefore, the disparity between left and right frames displayed on the stereo display device may not be an appropriate one for the viewer. FIG. 1A is a schematic view showing a binocular parallax S1 of a viewer 101 located at a greater distance from a stereo display device 102. FIG. 1B is a schematic view showing a binocular parallax S2 of the viewer 101 located at a shorter distance from a stereo display device 102. As shown in FIGS. 1A and 1B, the binocular parallax S1 of the viewer 101 located at a greater distance from the stereo display device 102 is significantly smaller than the binocular parallax S2 of the viewer 101 located at a shorter distance from the stereo display device 102.

Therefore, a need exists in the art for a stereo display device for displaying left and right frames alternately having an adjusted disparity in between.

### SUMMARY OF THE INVENTION

One object of the present invention is to adjust the disparity between left and right frames according to the distance between the stereo display device and the viewer so as to reduce the discomfort experienced by the viewer.

To achieve the aforementioned object, the present invention provides a stereo display device for displaying left and right frames alternately with an adjusted disparity in between, comprising: a distance measurement module configured to measure a distance between the stereo display device and a viewer; and an adjustment module configured to receive left and right frames with an original disparity in between, to adjust the original disparity between left and right frames according to the distance between the stereo display device and the viewer, and output left and right frames having an adjusted disparity in between.

The present invention provides another stereo display device for displaying left and right frames alternately with an adjusted disparity in between, comprising: a distance measurement module configured to measure the distances between the stereo display device and a plurality of viewers; and an adjustment module configured to receive left and right frames with an original disparity in between, to adjust the original disparity between left and right frames according to the distances between the stereo display device and the plurality of viewers with outputs of the left and right frames having an adjusted disparity in between.

The stereo display device of the present invention can effectively display left and right frames having an adjusted disparity in an alternating order.

### BRIEF DESCRIPTION OF THE DRAWINGS

FIG. 1A is a schematic view showing a binocular parallax of a viewer located at a greater distance from a stereo display device.

FIG. 1B is a schematic view showing a binocular parallax of the viewer located at a shorter distance from the stereo display device.

FIG. 2 is a schematic view showing a stereo display device in accordance with a first embodiment of the present invention.

FIG. 3A is a schematic view showing a pattern reflected by a viewer located at a greater distance from the projection module and received by the reception module.

FIG. 3B is a schematic view showing a pattern reflected off the viewer located at a shorter distance from the projection module and received by the reception module.

FIG. 3C illustrates the relationship between the spacing between the parallel lines of the reflected pattern and the distance between the viewer and the projection module.

FIG. 4 is a schematic view showing a stereo display device in accordance with a second embodiment of the present invention.

FIG. 5 shows an optical system comprising a movable lens assembly and a sensor.

FIG. 6 is a schematic view showing a stereo display device viewed by a plurality of viewers in accordance with an exemplary embodiment of the present invention.

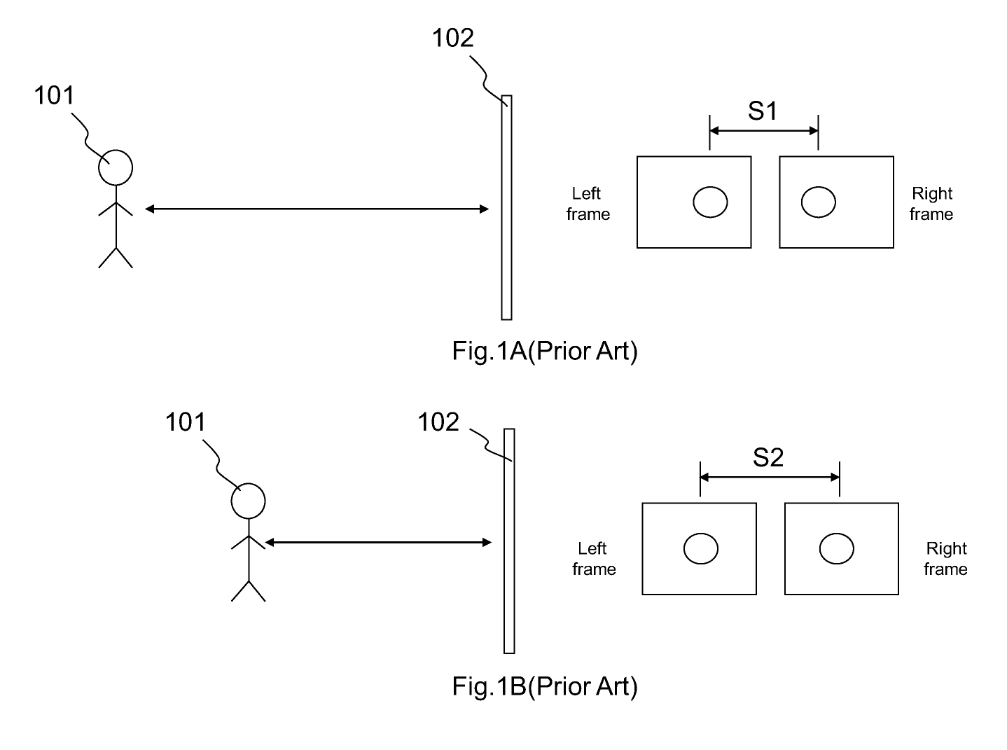

### DETAILED DESCRIPTION OF THE PREFERRED EMBODIMENTS

The present invention will be described more fully hereinafter with reference to the accompanying drawings, in which preferred embodiments of the present invention are shown.

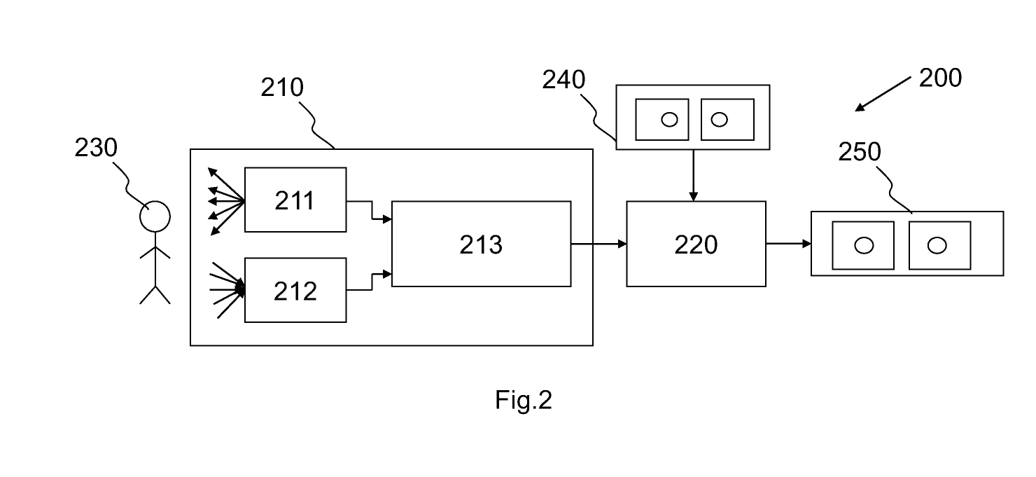

FIG. 2 is a schematic view showing a stereo display device 200 in accordance with a first embodiment of the present invention. As shown in FIG. 2, the stereo display device 200 alternately displays left and right frames having an adjusted disparity in between. The stereo display device 200 comprises a distance measurement module 210 and an adjustment module 220.

The distance measurement module 210 is configured to measure the distance between the stereo display device 200 and a viewer 230. The distance measurement module 210 comprises a projection module 211, a reception module 212 and a computation module 213. The projection module 211 projects a pattern to the viewer 230, and then the projected pattern will be reflected off the viewer 230. Therefore, the reception module 212 is provided to receive the image of the pattern reflected off the viewer 230. From the above, it is known that the reception module 212 receives the reflected projected pattern.

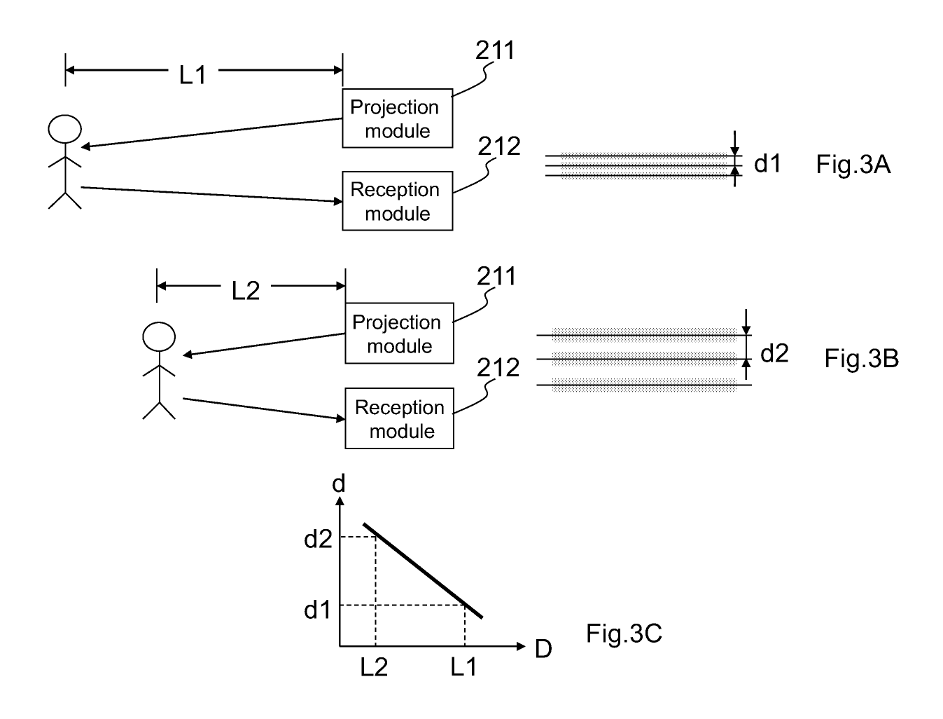

FIGS. 3A-3C illustrates the measurement of the distances between the projection module and the viewer in accordance with the first embodiment of the present invention. As shown in FIGS. 3A and 3B, the pattern includes several parallel lines. FIG. 3A is a schematic view showing a pattern (on the right side of the drawing) reflected off the viewer 230 located at a greater distance L1 from the projection module 211 and received by the reception module 212. FIG. 3B is a schematic view showing a pattern reflected off the viewer 230 located at a shorter distance L2 from the projection module 211 and received by the reception module 212. FIG. 3C illustrates the relationship between the spacing between the parallel lines of the reflected pattern and the distance between the viewer 230 and the projection module 211. The size of the reflected pattern varies when light is reflected at different locations. Therefore, the spacing d1 between the parallel lines of the pattern, which is reflected off the viewer 230 located at a greater distance from the projection module 211, is smaller (see the right side of FIG. 3A). Conversely, the spacing d2 between the parallel lines of the pattern, which is reflected off the viewer 230 located at a shorter distance from the projection module 211, is greater (see the right side of FIG. 3B). The above relationship allows the computation module 213 to calculate the distance between the stereo display device 200 and the viewer 230. While FIGS. 3A and 3B show a pattern for distance measurement, any pattern capable of being utilized to measure distances is considered to be within the scope of the present invention. Generally, any pattern in which the change in the distance between any two points can be identified is applicable in the present invention.

The adjustment module 220 receives left and right frames 240 with an original disparity in between. As described above, the original disparity between left and right frames 240 is equivalent to the disparity between left and right frames captured through photographing. The adjustment module 220 receives the distance between the stereo display device 200 and the viewer 230 from the distance measurement module 210, adjusts the original disparity between left and right frames according to the distance between the stereo display device 200 and the viewer 230, and outputs left and right frames 250 with an adjusted disparity. From the above, the adjusted disparity between left and right frames 250 would be more suitable for the viewer 230.

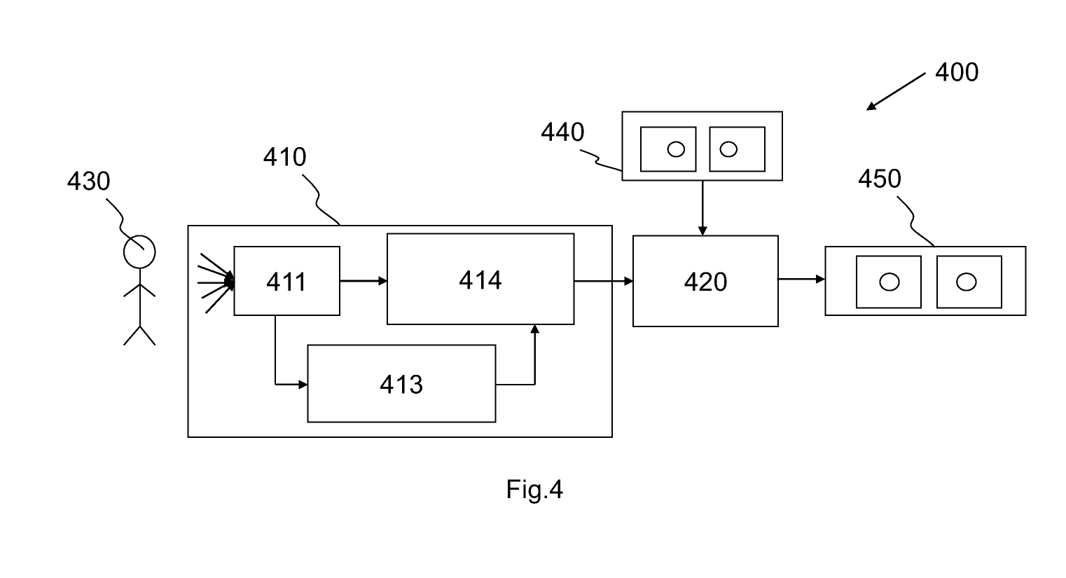

FIG. 4 is a schematic view showing a stereo display device 400 in accordance with a second embodiment of the present invention. As shown in FIG. 4, the stereo display device 400 displays left and right frames alternately having an adjusted disparity. The stereo display device 400 comprises a distance measurement module 410 and an adjustment module 420.

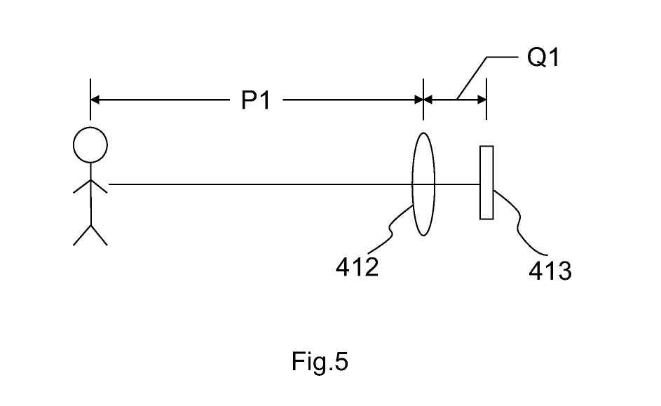

The distance measurement module 410 is configured to measure the distance between the stereo display device 400 and a viewer 430. The distance measurement module 410 comprises an image capturing module 411, which is provided with a movable lens assembly 412 and a sensor 413, and a computation module 414. When the distance between the movable lens assembly 412 and the sensor 413 changes (see FIG. 5), the image capturing module 411 captures a plurality of images of the viewer 430 to measure the distance between the stereo display device 400 and the viewer 430. Generally, the sensor 413 is provided with the definition detection function to identify the image with the best definition among the plurality of images of the viewer 430. After receiving the information as to which image has the best definition from the sensor 413, the computation module 414 receives the parameters adopted to capture the image with the best definition from the movable lens assembly 412.

FIG. 5 shows an optical system comprising the movable lens assembly 412 and the sensor 413. The focal length of the movable lens assembly 412 is f. After the computation module 414 receives the parameters of the movable lens assembly 412 from the sensor 413, the distance Q1 between the movable lens assembly 412 and the sensor 413, i.e. the image distance of the optical system, can be obtained. The computation module 414 can calculate the distance P1 between the viewer 430 and the movable lens assembly 412, i.e. the object distance of the optical system, through the Gaussian formula:

$$\frac{1}{P 1} + \frac{1}{Q 1} = \frac{1}{f} . \qquad ( 1 )$$

Accordingly, the computation module 414 can calculate the distance between the stereo display device 400 and the viewer 430.

The adjustment module 420 receives left and right frames 440 having an original disparity in between. As described above, the original disparity between left and right frames 440 is equivalent to the disparity between left and right frames captured through photographing. The adjustment module 420 receives the distance between the stereo display device 400 and the viewer 430 from the distance measurement module 410, adjusts the original disparity between left and right frames 440 according to the distance between the stereo display device 400 and the viewer 430, and outputs left and right frames 450 having an adjusted disparity in between. From the above, the adjusted disparity between left and right frames 450 would be suitable for the viewer 430.

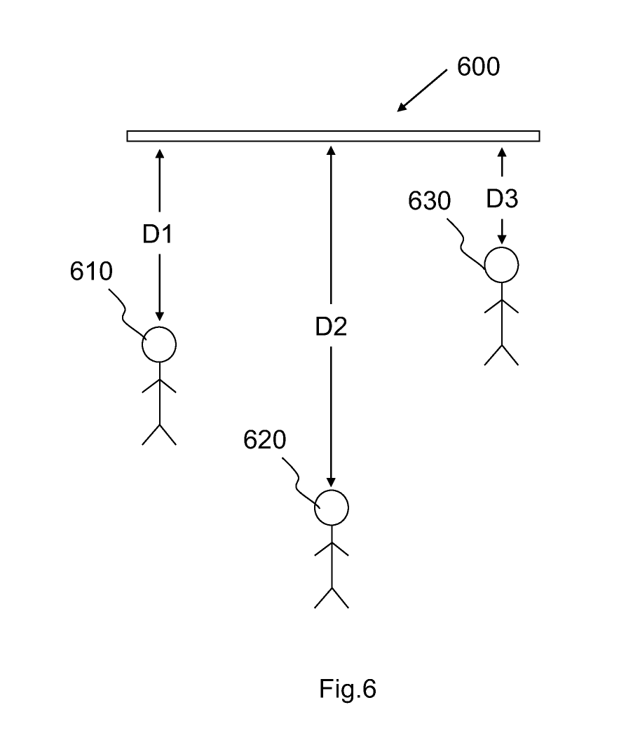

FIG. 6 is a schematic view showing a stereo display device 600 viewed by a plurality of viewers in accordance with an exemplary embodiment of the present invention. As shown in FIG. 6, the stereo display device 600 displays left and right frames alternately having an adjusted disparity. The stereo display device 600 comprises a distance measurement module and an adjustment module. The distance measurement module is configured to measure the distances between the stereo display device 600 and a plurality of viewers 610, 620 and 630. The distance measurement module 210 of the first embodiment as shown in FIGS. 2 and 3 may be used in this embodiment. For example, the distance measurement module of this embodiment comprises a projection module and a reception module. The projection module projects a pattern to the plurality of viewers 610, 620 and 630. The reception module receives images of the pattern reflected off the plurality of viewers 610, 620 and 630.

Alternatively, the distance measurement module 410 of the second embodiment as shown in FIGS. 4 and 5 may be used in this embodiment. For example, the distance measurement module of this embodiment comprises an image capturing module, which is provided with a movable lens assembly and a sensor. When the distance between the movable lens assembly and the sensor changes, the image capturing module captures a plurality of images of the plurality of viewers 610, 620 and 630 to measure the distances between the stereo display device 600 and the plurality of viewers 610, 620 and 630.

The adjustment module receives left and right frames having an original disparity in between, adjusts the original disparity between left and right frames according to the distances between the stereo display device 600 and the plurality of viewers 610, 620 and 630, and outputs left and right frames having an adjusted disparity in between. Moreover, the adjustment module can perform a weighted calculation on the distances between the stereo display device 600 and the plurality of viewers 610, 620 and 630, adjust the disparity between left and right frames according to the results of the weighted calculation, and output left and right frames having an adjusted disparity.

From the above, the stereo display device of the present invention can assign a weight to each viewer to perform a weighted calculation on the distances between the stereo display device and the plurality of viewers when the stereo display device is viewed by more than one viewer. Generally, the following formula is applied: D=α₁D₁+α₂D₂+α₃D₃ (2), wherein α₁+α₂+α₃=1 and D is the weighted distance resulting from the weighted calculation. The adjustment module adjusts the disparity between left and right frames according to the weighted distance and outputs left and right frames having an adjusted disparity. While FIG. 6 illustrates an exemplary number of viewers, the stereo display device of the present invention may be viewed by any number of viewers.

The aforementioned distance measurement modules 210 and 410 may be equipped with the human feature detection function to identify the locations of the viewers 230, 430, 610, 620 and 630. Generally, the distance measurement modules 210 and 410 are equipped with the face detection function to determine the locations of the viewers 230, 430, 610, 620 and 630.

While this invention has been described by way of examples and in terms of preferred embodiments, it is to be understood that this invention is not limited hereto, and that various changes, substitutions, and alterations can be made herein without departing from the spirit and scope of this invention as defined by the appended claims.

What is claimed is:

1. A stereo display device for displaying left and right frames alternately with an adjusted disparity in between, comprising:
a distance measurement module configured to measure a distance between the stereo display device and a viewer; and
an adjustment module configured to receive left and right frames with an original disparity in between, to adjust the original disparity between left and right frames according to the distance between the stereo display device and the viewer with outputs of the left and right frames having an adjusted disparity in between.

2. The stereo display device according to claim 1, wherein the distance measurement module is equipped with the human feature detection function.

3. The stereo display device according to claim 1, wherein the distance measurement module comprises a projection module configured to project a pattern to the viewer and a reception module configured to receive an image of the pattern reflected off the viewer.

4. The stereo display device according to claim 1, wherein the distance measurement module comprises an image capturing module provided with a movable lens assembly and a sensor, and wherein the image capturing module captures a plurality of images of the viewer when a distance between the movable lens assembly and the sensor changes so as to measure the distance between the stereo display device and the viewer.

5. A stereo display device for displaying left and right frames alternately with an adjusted disparity in between, comprising:
a distance measurement module configured to measure the distances between the stereo display device and a plurality of viewers; and
an adjustment module configured to receive left and right frames with an original disparity in between, to adjust the original disparity between left and right frames according to the distances between the stereo display device and the plurality of viewers with outputs of the left and right frames having an adjusted disparity in between.

6. The stereo display device according to claim 5, wherein the adjustment module performs a weighted calculation on the distances between the stereo display device and the plurality of viewers, adjusts the disparity between left and right frames according to the results of the weighted calculation and outputs left and right frames having an adjusted disparity in between.

7. The stereo display device according to claim 5, wherein the distance measurement module is equipped with the human feature detection function.

8. The stereo display device according to claim 5, wherein the distance measurement module comprises a projection module configured to project a pattern to the plurality of viewers and a reception module configured to receive multiple images of the patterns reflected off the plurality of viewers.

9. The stereo display device according to claim 5, wherein the distance measurement module comprises an image capturing module provided with a movable lens assembly and a sensor, and wherein the image capturing module captures multiple images of the plurality of viewers when a distance between the movable lens assembly and the sensor changes so as to measure the distances between the stereo display device and the plurality of viewers.
